(19) United States
(12) Patent Application Publication
(10) Pub. No.: US 2005/0289085 A1
(43) Pub. Date: Dec. 29, 2005

(54) Secure domain network

(75) Inventor: Gunnar Hamber, Skarholmen (SE)

Correspondence Address: PILLSBURY WINTHROP SHAW PITTMAN, LLP, P.O. BOX 10500, MCLEAN, VA, 22102, US

(73) Assignee: AU-SYSTEM AKTIEBOLAG (publ), Stockholm (SE)

(21) Appl. No.: 11/217,486

(22) Filed: Sep. 2, 2005

Related U.S. Application Data
(63) Continuation of application No. 10/050,064, filed on Jan. 15, 2002.

(30) Foreign Application Priority Data
Dec. 20, 2001 (SE) 0104344-7

(51) Int. Cl. H04L 9/00

(52) U.S. Cl. 705/67

(57) ABSTRACT

The present invention relates to a system and a method for providing a user (10) an authority to a secure domain (70, 80) in a network for data or telecommunication. A user, client, (10) requires the authority to the secure domain (70, 80) via a user-interface and at least one access code. User-certificate- and identification data corresponding to the access code is authenticated via an authenticating server (20). At least one access key pair is provided via an access server (60) if at least one of the identification data and certificate data is authenticated and the access key pair is stored in at least one user deposit module (50). The access key pair, through the interface, directly provides the authenticated user (10) the authority to enter the domain (70, 80) through a server access independent signal path (100, 110).

### TECHNICAL FIELD

The present invention pertains to a system and a method for providing a user an authority to a secure domain in a network for data or telecommunication.

### BACKGROUND ART

Current methods of providing safe communication over networks for data and telecommunication often involve PKI (Public Key Infrastructure) solutions for information encryption, signing or authentication wherein one secret code or a private key is used to firstly encrypt pieces of data and another public code or key is utilized to decode the encrypted data. Such solutions principally involve a CA (Certification Authority), i.e. a trusted certificate provider, issuing a secret code or key directly to an authorized client, user, and providing a public code or key in a directory or the like for collection when required for ensuring an authority, for example when a client, user, attempts to access specific locations, services or applications on the network where an authorization check is performed for maintaining a preset level of security.

A problem with utilizing PKI through an integrated platform at the client location as commonly accomplished, originates in the inflexibility and vulnerability of the security system configuration as a whole, among other matters referring to the access site-dependency i.e. in the case where a request to enter a secure network location, application or service fulfils the requirements for access granting, the requisites for providing access are previously distributed and stored locally in a secure device e.g. on a smart card or equivalent token, or in a protected area e.g. on a computer hard disc, a local server or the like local storage media often in the form of digital signatures and cryptographic keys embedded in an electronic document, protocol or script file. Whenever the requisites are stored locally in a protected area, access to this specific location subsequently also may be granted from a variety of different locations and computers depending on different accessing locations of the same authorized client, the same amount of possible unauthorized entryways exist to that secure network domain since such accessing information always will be downloaded and stored on media relating to respective new entryway. It could hence possibly be quite easy for an unauthorized entity to utilize such downloaded and locally stored access information to entry locations in what is called “secure” domains or for creating false access credentials. When the requisites are stored in a secure device, the access point to that device often is non-secure, e.g. through connection with the computers operating system or non-secure device drivers, subsequently causing analogous non-security considerations as with storing requisites in local storage media. Moreover there is a possibility that such accessing information, after being issued to a client by a CA, either is monitored or in some other way directly or indirectly intercepted by an unwanted entity seeking to force entry and manipulate contents in a secure location on the network.

Other problems relating to PKI authentication can also involve having to provide electronic authentication hardware or the like to a client following an access request and registration to a secure domain environment, representing a timely, costly and inflexible means of ensuring an authority for both the access seeking client and the administrator of the secure domain.

The above mentioned shortcomings with PKI security solutions, as currently mostly utilized, also constitutes a problem in the electronic communication between different trusted parties, for example between banks, each requiring a certain degree of network domain security and where one or several of the banks are. CA to their clients and possibly may not trust each others network security solutions nor be able to issue guarantees based on others CA-policies. The level of security for accessing the network in one of the banks may for example not reach a certain set security standard as claimed by another bank, maybe for marketing purposes, making such a claim more or less useless when, for example, electronic transactions between these two banks are to be executed or mainly when establishing a network connection between the banks altogether, through which an unauthorized entry then is more easily achievable via the lower level security system into the higher security level system.

Since most banks and other the like corporations, likewise public authorities, which utilizes networks for data and telecommunication as a means for e.g. communicating, information provision and financial transactions, want to attract and keep clients by means of presenting the most safe and secure network environment on the market for such activities, problems of mistrust and network security divergences in the association between companies are still to be solved.

There could also be compatibility problems between different potent network security solutions in companies wanting to cooperate with each other, wherein such problems would be difficult, costly and time-consuming to overcome with an overall maintained high level of security without making major changes to at least one of the companies network security structure.

There is hence a need for an intermediary network security solution, which serves as an entryway to enterprises, centrally encompassing and handling both PKI and non-PKI security environments as well as providing interoperability across existing security environments by utilizing alternative ways of authenticating users, maximizing convenience and productivity without compromising security.

### SUMMARY OF THE DISCLOSED INVENTION

The present invention relates to a system and a method for providing a user an authority to a secure domain, enabling direct access to secure applications and services in networks for data or telecommunication via inherent means for requesting, creating and distributing access key pairs for opening a communication to the domain through a server access independent signal path.

The system and method provides an intermediary functionality across different existing security solutions by utilizing existing user credentials for authenticity checking and, through system-integrated means for granting and providing an access according to stored user credentials and privileges, also achieves an equally high level of security towards every client-server communication.

Particularly the present invention provides a high level of security toward network domains independent of the kind of client authentication utilized for determining an authority.

To achieve aims and objectives the present invention provides a system for providing a user an authority to a secure domain in a network for data or telecommunication. The system comprises:

an interface to the user, requiring the authority through at least one access code;

an authenticating server, for authenticating user-certificate data and user-identification data corresponding to said access code;

an access server, for providing at least one access key pair if at least one of the identification data and certificate data is authenticated;

said access server having said access key pair stored in at least one user deposit module;

said access server providing said access key pair to said interface; and

whereby said access key pair directly provides the authenticated user the authority to enter said domain through a server access independent signal path.

In one embodiment of the system according to the present invention, means for checking access privilege-level data for the authenticated user are furthermore provided.

In a further embodiment of the system according to the present invention, the access key pair is arranged to directly access the authenticated user to the parts of the secure domain corresponding to the user-level of privilege, thus enabling an on-line provision of applications and services according to a preset level of priority, access or security requirements for domain entry for the authorised user in real-time.

In another embodiment of the system according to the present invention, the at least one access key pair is arranged to enable the user to encrypt, digitally sign and authenticate data relevant to the secure domain corresponding to the user-level of privilege, thus enabling an on-line provision of cryptographic measures according to a preset level of priority, access or security requirements in the security domain in real-time.

In one embodiment of the system according to the present invention, the access server is arranged to provide at least one new key pair for each user-attempt to access the secure domain, thus allowing a user only one access-attempt to a domain with the same key pair.

In another embodiment of the system according to the present invention, the access server is arranged to retrieve at least one previously stored access key pair for additional authority-requests to the domain following an initial domain authorization.

In yet another embodiment of the system according to the present invention, the access key pair is comprised in a virtual smart card.

In a further embodiment of the system according to the present invention, additional user authentications and subsequent additional access key pair requests are arranged to be performed each time a downloading sequence is completed when an initial access has been established, for maintaining an uninterrupted access.

In another embodiment of the system according to the present invention, initially generated and stored access key pairs are arranged to be retrieved via the access server in accordance with each additional request.

In yet another embodiment of the system according to the present invention, the access server is arranged to generate new access key pairs in accordance with each additional request.

In other embodiments of the system according to the present invention, at least three access key pairs are provided and stored in the user deposit module via the access server, a first key pair for authentication purposes, a second key pair for encryption purposes and a third key pair for digital signing purposes and the at least access three key pairs are comprised in a virtual smart card.

In further embodiments of the system according to the present invention, an interface to an authority is provided for validating user credentials and the user level of privilege is determined by stored privilege level data for the user.

In further embodiments of the system according to the present invention, the user level of privilege is determined by the user certificate data and identification data and the user level of privilege is determined by at least one of priority-, access- and security level data for domain entry.

The present invention further sets forth a method for providing a user an authority to a secure domain in a network for data or telecommunication. The method comprises the steps of:

requiring the authority via a user-interface, through at least one access code;

authenticating user-certificate data and user-identification data corresponding to said access code;

providing at least one access key pair via an access server, if at least one of the identification data and certificate data is authenticated;

having said access key pair stored in at least one user deposit module;

providing said access key pair to said interface; and

whereby said access key pair directly provides the authenticated user the authority to enter said domain through a server access independent signal path.

In one embodiment of the method according to the present invention, access privilege-level data is checked for the authenticated user.

In a further embodiment of the method according to the present invention, the access key pair directly accesses the authenticated user to the parts of the secure domain corresponding to the user-level of privilege, thus enabling an on-line provision of applications and services according to a preset level of priority, access or security requirements for domain entry for the authorised-user in real-time.

In another embodiment of the method according to the present invention, the at least one access key pair enables the user to encrypt, digitally sign and authenticate data relevant to the secure domain corresponding to the user-level of privilege, thus enabling an on-line provision of cryptographic measures according to a preset level of priority, access or security requirements in the security domain in real-time.

In one embodiment of the method according to the present invention, an access server provides at least one new key pair for each user-attempt to access the secure domain, thus allowing a user only one access-attempt to a domain with the same key pair.

In another embodiment of the method according to the present invention, an access server retrieves at least one previously stored access key pair for additional authority-requests to the domain following an initial domain authorization.

In yet another embodiment of the method according to the present invention, the access key pair is comprised in a virtual smart card.

In a further embodiment of the method according to the present invention, additional user authentications and subsequent additional access key pair requests are performed each time a downloading sequence is completed when an initial access has been established, for maintaining an uninterrupted access.

In another embodiment of the method according to the present invention, initially generated and stored access key pairs are retrieved via the access server in accordance with each additional request.

In yet another embodiment of the method according to the present invention, the access server generates new access key pairs in accordance with each additional request.

In other embodiments of the method according to the present invention, at least three access key pairs are provided and stored in the user deposit module via the access server, a first key pair for authentication purposes, a second key pair for encryption purposes and a third key pair for digital signing purposes and the at least access three key pairs are comprised in a virtual smart card.

In further embodiments of the method according to the present invention, an interface to an authority is provided for validating user credentials and the user level of privilege is determined by stored privilege level data for the user.

In further embodiments of the method according to the present invention, the user level of privilege is determined by the user certificate data and identification data and the user level of privilege is determined by at least one of priority-, access- and security level data for domain entry.

### BRIEF DESCRIPTION OF THE DRAWINGS

Henceforth reference is had to the attached figures for a better understanding of the present invention and its examples and embodiments, wherein:

FIG. 1 schematically illustrates an autonomous system for handling network domain security incorporating any prevailing security solutions and managing both PKI- and non-PKI aware applications, according to one embodiment of the present invention.

FIG. 2, according to another embodiment of the present invention, schematically illustrates a system for handling network domain security furthermore incorporating a privilege level check-up function.

FIG. 3 illustrates an alternative system for handling network domain security.

### WORDLIST

A VSC (Virtual Smart Card) constitutes multiple digital key pairs and corresponding digital certificates including storage and cryptographic functionality.

A digital certificate is the digital equivalent of an ID card used in conjunction with a public key encryption system.

A handheld computerized device can be a laptop computer, a PDA or the like device comprising cellular radio equipment or a WAP telephone device etc.

WAP (Wireless Application Protocol) enables a WWW connection through a cellular telephone.

A network for data or telecommunication can be the WWW or other like networks, Intranet, WAN, LAN etc.

A PDA (Personal Digital Assistant) is a handheld computer that serves as an organizer for personal information.

A LDAP (Lightweight Directory Access Protocol) is a protocol used to access a directory listing.

AD (Active Directory) is an advanced, hierarchical directory service that comes with Windows 2000.

NDS (Novell Directory Services) is based on the X.500 directory standard and is LDAP compliant.

### DETAILED DESCRIPTION OF PREFERRED EMBODIMENTS

The present invention sets forth a system and a method for providing a user an authority to a secure domain, enabling access to secure applications and services in networks for data or telecommunication, providing an intermediary functionality across different existing security solutions by utilizing existing user credentials for authenticity checking, and which through system-integrated means for granting and providing an access according to stored user credentials and privileges also provides an equally high level of security towards every client-server communication.

The capability of handling different authentication procedures together with system-inherent means for creating and providing customized keys for accessing on demand and for example according to pre-set privileges, is a significant advantage of the present invention, creating an independence of authentication method and requisites still providing an enhanced security for network domain accessing. This accomplishes a chain of security enhancing steps in accordance with (user-logon-point of trust-logon-access), in comparison with the prior art chain of steps (user-logon-access). Hereby the point of trust determines a new set of security steps in different levels depending on the users needs, privileges or other settings.

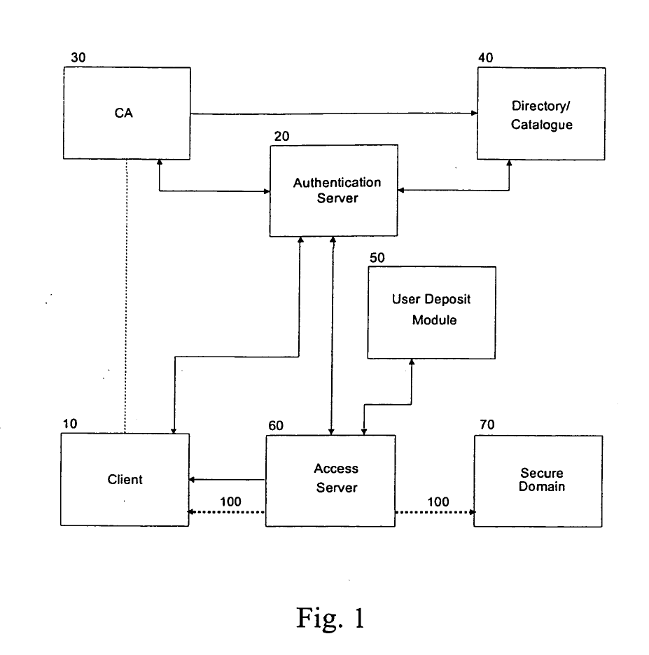

FIG. 1, according to one embodiment of the present invention, illustrates an autonomous intermediary system for managing network domain security incorporating prevailing security solutions handling both PKI- and non-PKI aware applications residing within a secure network domain. A user or client 10, which could be either a physical person or a software application, internally or from an external location via a computerized interface e.g. through a stationary- or portable computer, a PDA, a WAP-telephone device or the like handheld computerized device, requires an authority to a secure domain, for example having at least one of a number of applications and services, in a network for data or telecommunication.

An authenticity verification procedure is executed, wherein the client 10 initially is requested to submit an any existing accessing credentials, access codes, via the interface to an authentication server 20, which either accepts such credentials, access codes, at face value or performs a credential lookup before granting or denying an authority to access for example depending on a preset security level for accessing the particular domain, application, service or location on the network as requested.

For providing an authority to a high security domain 70, where a corporate internal PKI-security solution for example is utilized, such a credential lookup can include that the client 10 for example on the credential request initially provides a digital certificate encrypted with a private key issued by a CA 30 (Certification Authorizer). The authenticating server 20 can then collect the corresponding public key from a particular directory 40, for example a LDAP compliant directory or catalogue on the network, where it has been stored by the CA 30, for decoding, unlocking, the encrypted certificate and can thereby through certificate-inherent data, for instance a digital signature, verify the authenticity of the authority-requesting requesting client 10.

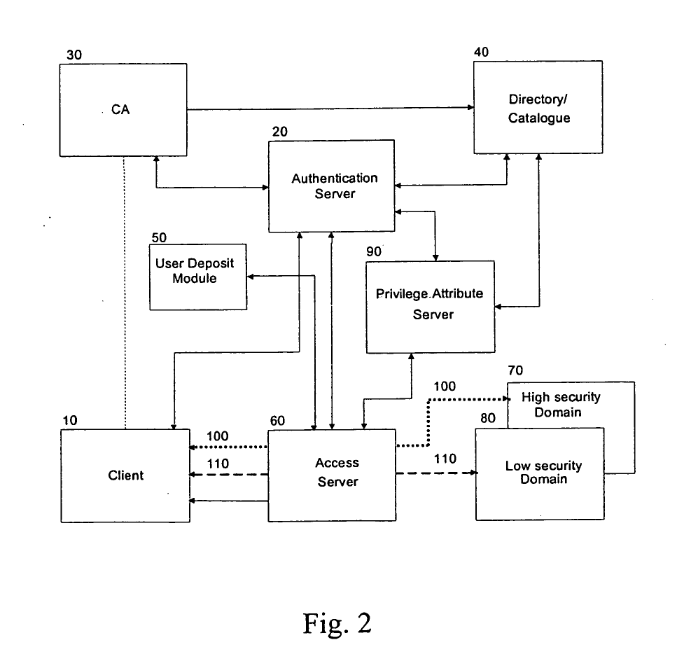

An alternative authentication and subsequent credential lookup procedure, for example according to a lower security level access request and utilizing a non-PKI solution for accessing in a low security domain 80, as illustrated in FIG. 2, can for example be accomplished by just comparing the on-request submitted access code or client credentials, which for example can be a username and a password or just the client's personal name or the like generalized credential information, with corresponding credential data for the client 10, either pre-stored locally in the authenticating server-20 itself or stored in a directory/catalogue 40 in a local or remote company server, from where such data can be collected for matching by the authenticating server 20, when required.

Other means of authenticating an access-requesting client 10 via the authenticating server 20 both via PKI and non-PKI solutions, can for example include the use of smart cards or hardware tokens, random password generators and soft certificates as well as just via a general personal on-line registration, for granting an authority to a domain in real-time without requiring any further special log-on requisites, all depending on the level of security, access or priority required for the applications, services and locations within the network domain.

When the authority-requesting client 10 has been authenticated, for example according to one of the above-mentioned procedures, client authorization to the requested domain can be granted and at least one access key pair is provided via an access server 60. The at least one access key pair is stored in at least one user deposit module 50 for further provision to the authenticated client 10 by the access server 60 via the client interface, thus directly providing the authenticated user 10 an authority for domain entry, for handling of domain-relevant data and to directly access applications, services and locations within the secure domain 70, as initially requested through a server access independent signal path 100 established. Thus bypassing the access server 60 as indicated trough the dotted line signal path 100.

As the key pair or key pairs thus directly open the communication channel as requested between the client 10 and the domain 70, an independence towards the authorizing system is achieved for maintaining the established connection even in cases when the authorizing system for example experiences problems relating to system and/or server failures and/or crashes and the like.

A user deposit module can be an encrypted memory space on a server. A single user can also have multiple personal user deposit modules on a server, each module can be intended for different areas of interest, for example in one module storing access keys for the personal bank account on the network, a second module having access keys for entering the secluded membership homepage maybe of the favourite football fan club and so forth.

In FIG. 2 according to an alternative embodiment of the present invention, is illustrated that a client privilege profile also can be determined when client authorization is granted, either according to one or both of credential and privilege data for the client 10, for example pre-stored locally in a privilege attribute server 90 or collected from a local or remote company server 40 to the privilege attribute server 90 or a combination of both.

Alternatively, individual client privileges can be assigned based upon predefined rules, for example according to one of a pre-set range of security levels corresponding to the type of client authentication utilized for access granting. Client access privileges can alternatively also be determined based upon pre-stored credential and privilege data collected from at least one of the above-described servers in combination with a set security level of the authentication method utilized for determining the authority.

Access privilege data for the client can for example be provided via look-up tables in the database servers.

A request for access key pairs for opening the client-requested access link, channel, is then sent to an access server 60, for example through an access key requesting means, communicating with the privilege attribute server 90 and from there forwarding the client privilege profile established for the authenticated client. The access server 60 provides or generates the requested access key pairs in accordance with the provided privilege profile data for the authorized client and stores the access key pair or pairs in a user deposit module 50. At least one key pair can be stored in at least one user deposit module 50 for further provision to the client by the access server 60, thus directly providing the authenticated user 10 an authority to handle domain-relevant data and to access applications and services within the secure domain 70, 80, which also corresponds to the user-level of privilege, through a server access independent signal path 100, 110.

Alternatively, according to one embodiment of the present invention, the access key pairs are on demand retrieved from at least one of access server storage or user deposit module storage when an initial key generation and storing sequence has been performed previously on demand, for example for maintaining a higher network security by frequent subsequent client authentications and access key pair requests following an initial access connection.

In one embodiment of the invention, the provided or generated access key pairs on-line and in real-time directly opens the communication as requested by the client 10 and according to the authenticated client's individual privileges. The client, user, 10 then directly accesses the parts of the secure domain 70, 80 corresponding to the client-level of privilege, thus enabling an on-line real-time provision of applications and services according to a preset level of priority, access or security requirements for domain entry for the authorised client 10.

In another embodiment of the present invention, the access key pairs enables the user 10 to encrypt, digitally sign and authenticate data relevant to the secure domain 70, 80 in correspondence to the user-level of privilege, thus enabling an on-line provision of cryptographic measures according to a preset level of priority, access or security requirements in the security domain in real-time

In an embodiment of the present invention, the client 10 upon authentication initially can be granted access to the full contents of the secure domain 70, 80 and a privilege profile check-up can be performed first at the network domain entrance, where collected privilege data for the client determines individual boundaries for access further into the domain.

In one embodiment of the present invention, the access server 60 generates at least one new key pair for each request to access the secure domain, thus allowing a client only one access attempt to a domain with the same key pair, hindering further use of that key pair.

In another embodiment of the present invention, additional user authentications and subsequent additional access key pair requests can be performed continuously according to preset time intervals when an initial access has been established, thus maintaining an uninterrupted access for the authenticated user.

In a further embodiment of the present invention, additional user authentications and subsequent additional access key pair requests can be performed continuously according to preset time intervals when an initial access has been established, thus maintaining an uninterrupted access for the authenticated client.

In one embodiment of the present invention, the access server 60 provides at least one previously stored access key pair for additional authority-requests to the domain 70, 80 following an initial domain authorization.

In another embodiment of the present invention, at least three access key pairs are provided and stored in the user deposit module 50 via the access server 60. A first key pair for authentication purposes, a second key pair for encryption purposes and a third key pair for digital signing purposes.

In a further embodiment of the present invention, the three access key pairs are comprised in a virtual smart card.

After a successful authentication of the client following one of the above-mentioned steps, according to one embodiment of the present invention, a Virtual Smart Card (VSC) can either be downloaded to the client or otherwise provided to open the communication channel for access according to client request and privileges. Such a VSC can for example contain the digital access key pairs and corresponding client digital certificates, arranged to access the client to predefined applications and services within a security domain.

According to one embodiment of the present invention, both the on demand generated access key pairs and the VSC can be arranged to allow a limited domain access only and either be automatically deleted on application, service or location exit, log off and shut down, on screen saver activation or according to a preset time limit.

The CA systems are perhaps not known and can vary. Therefore the CA Interface of the system can be generalized, which offers a variety of integration possibilities.

The system and method according to the present invention provides a security-enabling configuration, designed to integrate PKI into an already existing environment. The configuration is designed to allow the client, user, to authenticate using different methods, such as smart cards with certificates, password-generating devices or perhaps only username and password.

According to one embodiment of the present invention, at least one AD-, NDS-, X500 directory or the like LDAP compliant directory or catalogue can be used to store the user, client, certificates and credentials on the network.

The Certificate Authority software can be an off-the-shelf product and does not have to be customized for functioning in the system according to the present invention.

The configuration provides functionality to match a users authentication data with a Virtual Smart Card. When the user has retrieved the VSC, this can be used to access both non-PKI and PKI enabled systems.

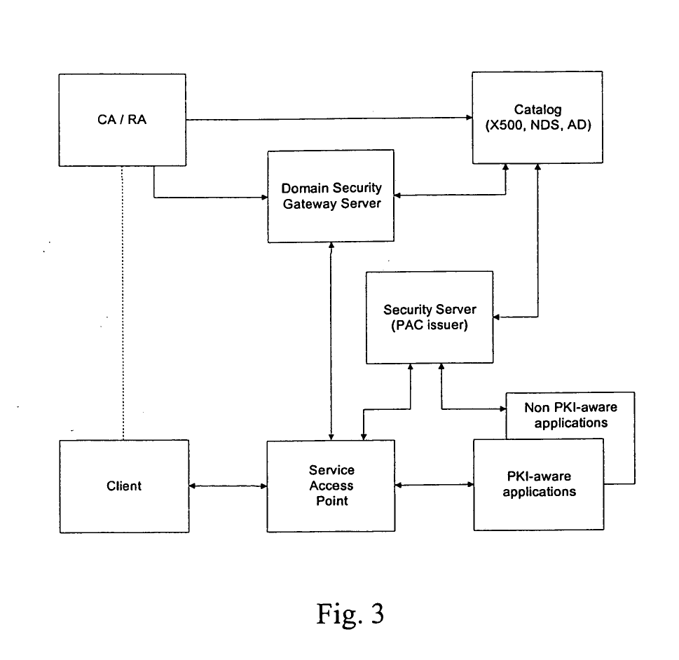

FIG. 3 illustrates an alternative embodiment of the present invention, wherein a first part of the system can be called “The Domain Security Gateway Server”. This Server can store access key pairs and can also provide them to the user, when they are needed.

A second part of the system can then be called “The Domain Security Gateway Client”. This Client could be either a Java applet or a small application and the Client is responsible for authenticating the user, downloading and storing the key pairs from the server and can act as a security-enabling interface towards the external systems.

A third part of the system can be called “The Certificate Authority Interface” or CA interface. The CA can issue the user certificates for the VSC and the CA interface generates the keys and binds them together with the corresponding digital user certificates.

The Crypto Functionality in the Domain Security Gateway (DSG) Server as well as the DSG Client can be provided by an external source, such as Baltimore, IAIK or RSA Security.

Also called “digital IDs,” digital certificates are issued by trusted third parties known as certification authorities (CAs) such as VeriSign, Inc., Mountain View, Calif., (www.verisign.com), after verifying that a public key belongs to a certain owner. The certification process varies depending on the CA and the level of certification. The digital certificate is actually the owner's public key that has been digitally signed by the CA's private key. The digital certificate is sent along with the digital signature to verify that the sender is truly the entity identifying itself in the transmission. The recipient uses the widely known public key of the CA to decrypt the certificate and extract the sender's public key. Then the sender's public key is used to decrypt the digital signature. The certificate authorities have to keep their private keys very secure, because if they were ever discovered, false certificates could be created.

X.509 is a widely used specification for digital certificates that has been a recommendation of the ITU (International Telecommunications Union) since 1988. Following is an example of certificate contents.
Version number (certificate format)
Serial number (unique value from CA)
Algorithm ID (signing algorithm used)
Issuer (name of CA)
Period of validity (from and to)
Subject (user's name)
Public key (user's public key & name of algorithm)
Signature (of CA)

The means for checking access privilege-level data for an authenticated user can be one or several of a multitude of known hardware and/or software means.

Means for requesting multiple access key pairs for the authenticated user can be provided in accordance with those known in the art for-different authentication, log on and access methods.

A computerized interface can e.g. be a PDA, a laptop or stationary computer, a cellular telephone with WAP capability or the like handheld or stationary computerized means for connection with a network of databases.

Means mentioned in the present description can be software means, hardware means or a combination of both.

The present invention has been described with non-limiting examples and embodiments. It is the attached set of claims that describe all possible embodiments for a person skilled in the art.

1. A system for providing a user an authority to a secure domain in a network for data or telecommunication, comprising:
an interface to the user, requiring the authority through at least one access code;
an authenticating server, for authenticating user-certificate data and user-identification data corresponding to said access code;
an access server, for providing at least one access key pair if at least one of the identification data and certificate data is authenticated;
said access server having said access key pair stored in at least one user deposit module;
said access server providing said access key pair to said interface; and
whereby said access key pair directly provides the authenticated user the authority to enter said domain through a server access independent signal path

2. A system according to claim 1, furthermore comprising means for checking access privilege-level data for the authenticated user.

3. A system according to one of claim 1, wherein the access key pair is arranged to directly access the authenticated user to the parts of the secure domain corresponding to a user-level of privilege, thus enabling an on-line real-time provision of applications and services according to a preset level of priority, access or security requirements for domain entry for the authorized user.

4. A system according to one of claim 1, wherein the access key pair is arranged to enable the user to encrypt, digitally sign and authenticate data relevant to the secure domain in correspondence to a user-level of privilege, thus enabling an on-line provision of cryptographic measures according to a preset level of priority, access or security requirements in the security domain in real-time.

5. A system according to claim 1, wherein the access server is arranged to provide and store at least one new access key pair for each user-attempt to access the secure domain, allowing a user only one access attempt to a domain with the same access key pair.

6. A system according to claim 1, wherein the access server is arranged to provide at least one previously stored access key pair for additional authority requests to the domain following an initial domain authorization.

7. A system according to claim 1, wherein the access key pair is comprised in a virtual smart card.

8. A system according to claim 1, wherein at least three access key pairs are provided and stored in the user deposit module via the access server, a first key pair for authentication purposes, a second key pair for encryption purposes and a third key pair for digital signing purposes.

9. A system according to claim 8, wherein the at least three access key pairs are comprised in a virtual smart card.

10. A system according to claim 1, having an interface to an authority for validating user-credentials.

11. A system according to claim 2, wherein the user-level of privilege is determined by stored privilege level data for the user.

12. A system according to claim 2, wherein the user-level of privilege is determined by the user certificate data and user identification data.

13. A system according to claim 2, wherein the user-level of privilege is determined by at least one of priority-, access- and security-level data for domain entry.

14. A method for providing a user an authority to a secure domain in a network for data or telecommunication, comprising:
requiring the authority via a user-interface, through at least one access code;
authenticating user-certificate data and user-identification data corresponding to said access code;
providing at least one access key pair via an access server, if at least one of the identification data and certificate data is authenticated;
having said access key pair stored in at least one user deposit module;
providing said access key pair to said interface; and
whereby said access key pair directly provides the authenticated user the authority to enter said domain through a server access independent signal path

15. A method according to claim 14, wherein access privilege-level data is checked for the authenticated user.

16. A method according to claim 14, wherein the access key pair directly accesses the authenticated user to the parts of the secure domain corresponding to the user-level of privilege, thus enabling an on-line real-time provision of applications and services according to a preset level of priority, access or security requirements for domain entry for the authorized user.

17. A method to claim 14, wherein the access key pair enables the user to encrypt, digitally sign and authenticate data relevant to the secure domain in correspondence to a user-level of privilege, thus enabling an on-line provision of cryptographic measures according to the present level of priority, access or security requirements in the secure domain in real-time.

18. A method according to claim 14, wherein an access server provides and stores at least one new access key pair for each user-attempt to access the secure domain, allowing a user only one access attempt to a domain with the same access key pair.

19. A method according to claim 14, wherein an access server provides at least one previously stored access key pair for additional authority-requests to the domain following an initial domain authorization.

20. A method according to claim 14, wherein the access key paid is comprised in a virtual smart card.

21. A method according to claim 14, wherein at least three access key pairs are provided and stored in the user deposit module via the access served, a first key pair for authentication purposes, a second key pair for encryption purposes and a third key pair for digital signing purposes.

22. A method according to claim 21, wherein the at least three access key pairs are comprised in a virtual smart card.

23. A method according to claim 14, wherein user-credentials are validated via an interface to an authority.

24. A method according to claim 14, wherein the user-level of privilege is determined by stored privilege level data for the user.

25. A method according to claim 14, wherein the user-level of privilege is determined by the user-certificate data and user-identification data.

26. A method according to claim 14, wherein the user-level of privilege is determined by at least one of priority-, access- and security-level data for domain entry.
